(19) United States
(12) Patent Application Publication
(10) Pub. No.: US 2023/0137753 A1
(43) Pub. Date: May 4, 2023

(54) Method for Securing Cargo Boxes Upon the Bed of a Pick-up Truck; Device for Securing Cargo Boxes Upon the Bed of a Pick-up Truck

(71) Applicant: Louis David Kristoff, Highland, IN (US)

(72) Inventor: Louis David Kristoff, Highland, IN (US)

(21) Appl. No.: 17/849,616

(22) Filed: Jun. 25, 2022

Related U.S. Application Data
(60) Provisional application No. 63/275,262, filed on Nov. 3, 2021.

(51) Int. Cl. B60P 7/08

(52) U.S. Cl. CPC B60P 7/0807; B60P 7/0823

(57) ABSTRACT

A method for securing cargo boxes upon the bed of a pick-up truck includes the steps of securing cargo rings to a structural portion of each inner side wall of the pick-up truck; determining the distance separating adjacent cargo rings; providing strap members having connecting hooks that are detachable secured to adjacent cargo rings; and securing a preselected quantity of strap rings to each strap member, the strap rings ultimately receiving cross straps that engage top portions cargo boxes to forcibly urge the cargo boxes upon the floor of the pick-up truck.

This Utility Application based on Provisional Application No. 63/275,262 filed Nov. 3, 2021.

### BACKGROUND OF THE INVENTION

### 1. Field of the Invention

This invention relates to a method and device for securing cargo boxes upon a floor of a truck; and in particular to securing cargo boxes on the bed of a pick-up truck.

### 2. Background of the Prior Art

Prior art devices and methods for securing cargo boxes upon the bed of a pick-up truck include ratchet ends (see U.S. Pat. Nos. 1,272,821 and 8,882,417) that enable strap portions of the device to be secured to cargo rings attached to inner side walls of the pick-up truck; whereby a user can remove all slack in the strap and generate excessive tensile stress in the strap and upon the ratchet ends of the strap. Further, when an operator is driving the pick-up truck upon undulating roads or around tight bends, the forces of motion when added to the tensile stress in the strap can cause a ratchet end of the strap to release or otherwise slip; resulting in cargo boxes secured by cross straps detachably secured to opposing strap portions of the device upon the bed of the pick-up, are released and free to move upon the pick-up truck bed causing damage to the truck and/or injury to the drivers or other vehicles.

Further, the strap portions of the prior art patents include apertures that removably receive hook ends of cross straps urging the cargo boxes upon the truck bed. When the cross straps are stretched to generate tensile force upon the cargo boxes after the cross strap hooks are secured to the apertures in the strap portion, the cross straps tend to rotate and twist thereby reducing the surface area of the cross strap that engages the top portion of the cargo boxes and correspondingly reducing the total force urging the bottom of the cargo boxes upon the bed of the truck, resulting in the cargo boxes being released and allow to cause damage to the pick-up truck, driver and/or other vehicles.

A need exists for a method and device for securing cargo boxes upon a floor or bed of a truck without using a ratcheted connector to secure a strap member to cargo rings attached to inner side walls of truck. Further, there is a need for the strap member to include a ring having a linear portion integrally joined to the strap member, and the ring having an arcuate portion separated from the strap member; whereby, the ring separates hook portions of cross straps from the strap member after the cross straps have been stretched to secure cargo boxes to the bed or floor of the pick-up truck when the hook portion engages the arcuate portion of the ring, thereby preventing the strap member and cross straps from twisting.

### SUMMARY OF THE INVENTION

It is a principal object of the present invention to provide a method and device for securing cargo boxes upon the bed of a pick-up truck. A feature of the method and device is the securing of a strap member to each inner side wall of the pick-up truck via cargo rings, whereby connecting hooks integrally joined to end portions of each strap member provide a length between outer ends of the connecting hooks greater than the distance separating the cargo rings on each side wall of the truck, resulting in a sag in the mid-portion of the strap member when connected to the cargo rings. An advantage of the method and device is that an acute angle of a force vector is formed relative to the surface of the inner side walls of the truck, thereby reducing the force lineally aligned with the cargo rings and correspondingly reducing the force generated by the tensile force of the cross straps, resulting in the reducing of the force urging the cargo rings toward each other that would otherwise damage the cargo rings.

Another object of the present invention is to provide a method and device for securing cargo boxes upon the bed of a pick-up truck that prevents tensile force imparted upon the strap member from being reduce by slippage or totally released. A feature of the method and device is eliminating ratchet connections for the strap members to the cargo rings. An advantage of the method and device is that the connecting hooks will not release the strap members from the cargo rings, irrespective of the force generated by cross straps connected to the strap members. Another advantage of the method and device is that by preventing the sudden release of the tension generated by ratchet straps upon restrained cargo boxes, movement of the cargo boxes is avoided that can damage the inner side walls of the pick-up truck and/or cause injury to the driver of the pick-up truck.

Yet another object of the present invention is to provide a method and device for securing cargo boxes upon the bed of a pick-up truck that provides strap rings integrally secured to and vertically positioned upon strap members. A feature of the method and device is the integral securing of a base portion of the strap rings between two layers of the strap members, whereby an arcuately configured retaining loop of the strap rings is disposed vertically, thereby enabling the “peak” portions of the arcuately configured retaining loops to be displaced from a centerline of the strap members to detachably receive end portions of cross straps without causing the strap members or the cross straps twisting or rotating due to the strap rings being separated from the end portion hooks of the cross straps and from the strap members. An advantage of the method and device is that preventing the strap members and cross straps from twisting, correspondingly reduces damage to the strap members and maintains the entire surface area of the cross straps upon the top portions of the cargo boxes, thereby increasing the total force urging the bottom portions of the cargo boxes upon the bed of the pick-up truck.

### BRIEF DESCRIPTION OF THE DRAWINGS

Objects, advantages and novel features of the present invention, as well as details of an illustrative embodiment thereof, will be understood from the following detailed description and attached drawings, wherein:

FIG. 1 is a back perspective view of a pick-up truck having a device for securing cargo boxes upon the bed of the pick-up truck; the device includes two opposing strap members detachably secured to cargo rings attached to both inner side walls of the pick-up truck, and multiple cross straps connected to the strap members that engage the cargo boxes in accordance with the present invention.

FIG. 2a is a side elevation view of an end portion of a strap member having a connecting hook with an annular base attached thereto.

FIG. 2b is a side elevation view of an end portion of a strap member having a connecting hook with a rectangular base attached thereto.

FIG. 3 perspective view of the end portion of the strap member of FIG. 2a detachably secured to a cargo ring, which is secured to a structural portion of an inner side wall of the pick-up truck.

FIG. 4 is a perspective view of a strap ring integrally secured between two layers of material that forms the strap member.

### DESCRIPTION OF THE PREFERRED EMBODIMENT

Referring now to the drawings, a method and device 8 for securing cargo boxes in the bed of a pick-up truck in accordance with the present invention includes determining the distance separating pairs of cargo rings 10 and 11 previously installed and secured to each inner side wall 12 of a bed 14 of a pick-up truck 16. Although the pairs of cargo rings 10 and 11 are may be factory installed, the user of the method may be required to secure a pair of cargo rings 10 and 11 to a structural portion 18 of each inner side wall 12 of the bed 14 of the pick-up truck 16. The user installed cargo rings 10 and 11 should be substantially the same as the factory installed cargo rings 10 and 11. The cargo rings 10 and 11 are secured to the inner side wall 12 about two inches above top portions 6 of wheel wells 7, thereby preventing engagement between the wheel wells 7 and first and second strap members 20 and 21 that ultimately connect to respective pairs of the cargo rings 10 and 11.

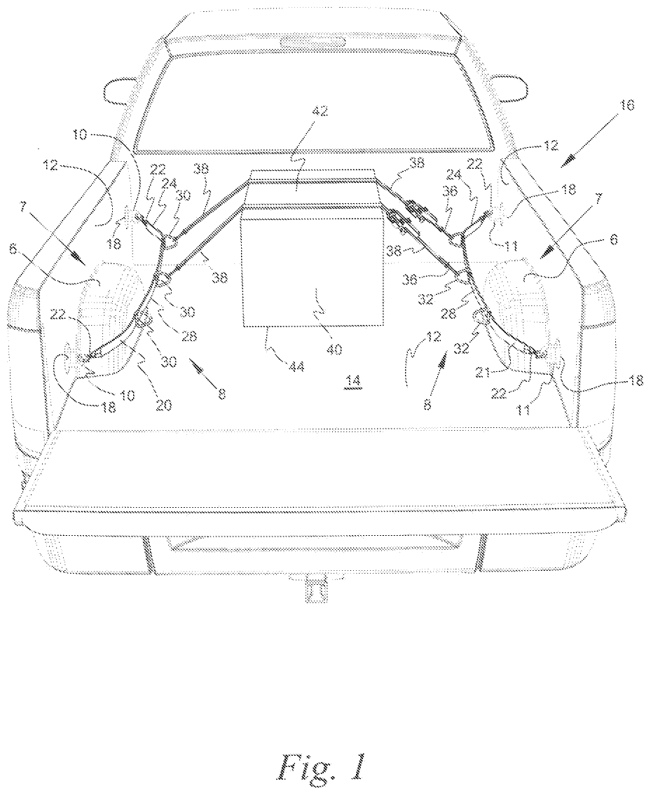

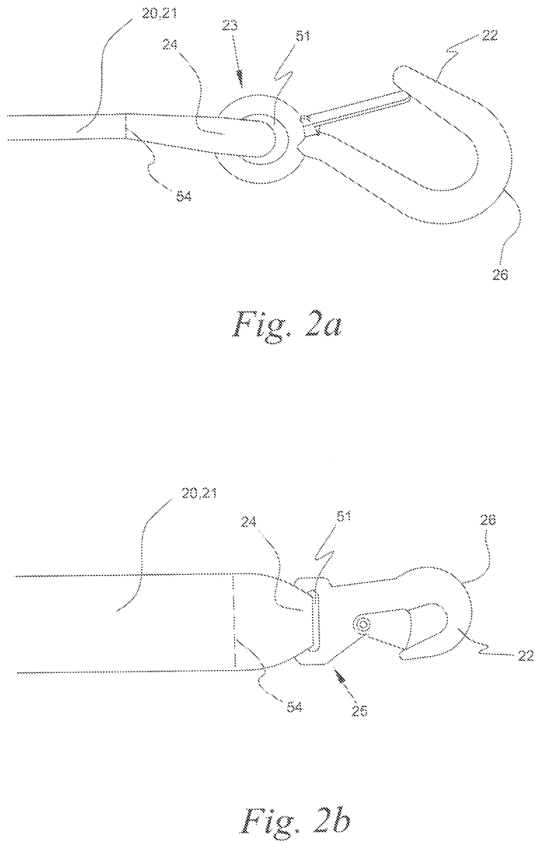

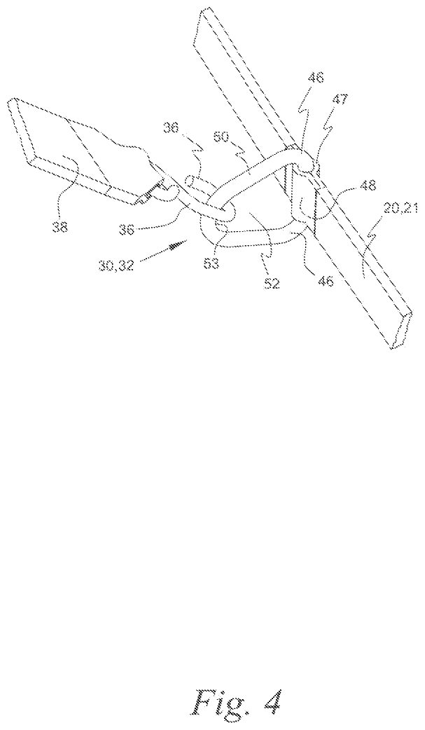

The method requires the user to determine the distance separating cooperating pairs of the cargo rings 10 and 11. After obtaining the distance, the user must provide connecting hooks 22 that are secured to end portions 24 of the strap members 20 and 21. The user has the option of selecting a connecting hook 22 with an annular portion 23 (FIG. 2a) or with a rectangular base 25 (FIG. 2b) for either end portion 24 of the strap members 20 and 21. The preferred orientation of the strap members 20 and 21 is a vertical position as depicted in FIG. 2b, but the orientation of the cargo rings 10 and 11 can vary, whereby the connecting hook 22 having an annular portion 23 (FIG. 2a) is required. Further, a swivel (not depicted) can be integrally joined between the annular portion 23 and the hook portion of the connecting hook 22; whereby the annular portion 23 and the strap members 20 and 21 are free to rotate to any position, resulting in the strap members 20 and 21 rotating from a vertically orientation to an angled position that cooperates with cross straps 38 angularly extending from a top wall 42 of a cargo box 40, when cross straps 38 are secured to the strap rings 30 and 32 and a tensile force is urged upon the cross straps 38 (see FIGS. 1 and 4).

The longitudinal dimension of each strap member 20 and 21 with the attached connecting hooks 22 is must have a length between end portions 26 of the connecting hooks 22 that is relatively longer (preferably between six and ten inches) than the distance separating a cooperating pair of cargo rings 10 and 11. The lengths of the strap members 20 and 21 with the connecting hooks 22 enables each strap member 20 and 21 to be secured to a corresponding inner side wall 12 of the pick-up truck 16, whereby each strap member 20 and 21 sags at a midportion 28 that is ultimately disposed at a predetermined distance from a respective side wall 12 of the truck 16 when a tensile force is ultimately applied to the strap members 20 and 21.

Before connecting the strap members 20 and 21 to the connecting hooks 22, a preselected quantity of strap rings 30 must be integrally secured to strap member 20, and the same quantity of strap rings 32 should be integrally secured to strap member 21. The preferred arrangement of the strap rings 30 and 32 is to position the strap rings 30 and 32 opposite each other, whereby cross straps 38 connected to the strap rings 30 and 32 are orientated perpendicular to the side walls 12 of the truck 16 when each cross strap 38 engages a top portion 42 of cargo boxes 40. Further, multiple cross straps 38 can be connected to each strap ring 30 and 32, thereby enabling cross straps 38 to be orientated perpendicularly and at acute angles to the side walls 12 of the truck 16, resulting in more force from multiple cross straps 38 being applied to top portions 42 of cargo boxes 38 for maintaining bottom portions 44 of the cargo boxes 40 upon the bed 14 of the truck 16.

The cross straps 38 are well known to those of ordinary skill in the art and include, but not limited to ratchet straps, bungee cords, ropes and combinations thereof. The cross straps 38 are adjustable in length and include end portions 36 that detachably secure to the strap rings 30 and 32. After the cross straps 38 are connected to cooperating strap rings 30 and 32, the cross straps 38 lengths are forcibly “stretched” to generate sufficient tensile force that removes the sag from the midportion 28 from the strap members 20 and 21, thereby forcibly separating the strap members 20 and 21 from corresponding inner side walls 12 of the pick-up truck 16. The generated tensile force from the cross straps 38 ultimately results in the cross straps 38 forcibly engaging the top portions 42 of the cargo boxes 40 and correspondingly urging the bottom portions 44 of the cargo boxes 40 upon the bed 14 of the pick-up truck 16, thereby maintaining the position of the cargo boxes 40 upon the bed 14 of the pick-up truck 16, irrespective of the vertical movement of the bed 14 or the directional changes of the pick-up truck 16.

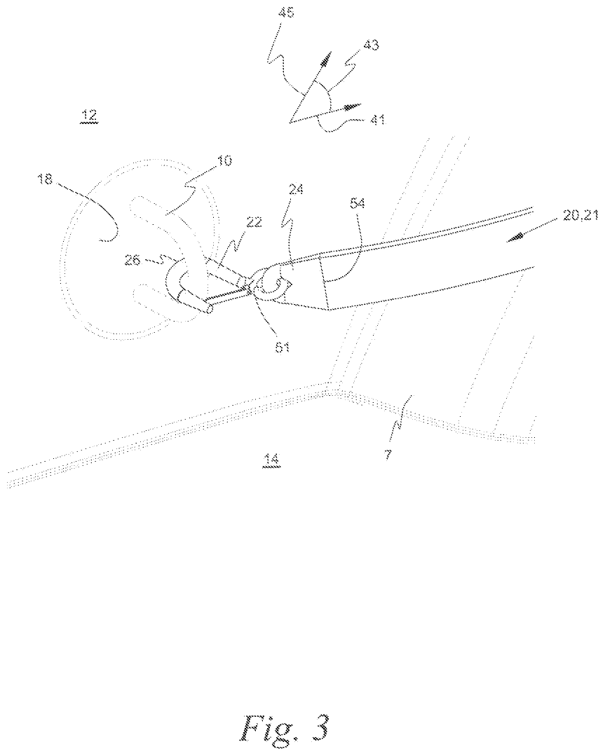

After the cross straps 38 are forcibly stretched, the midportions 28 of the strap members 20 and 21 are positioned a predetermined distance from the inner side walls 12 of the pick-up truck 16; whereby, the force (or force vector 41, see FIG. 3) imparted upon the end portions 24 of the strap members 20 and 21 forms and angle 43 of about forty degrees between the end portions 24 and the inner side walls 12 of the truck 16. The force imparted upon the angularly disposed end portions 24 of the strap members 20 and 21 is transferred to the cargo rings 10 and 11, but the forty degrees angle reduces the force urging the cargo rings 10 and 11 together via a force vector 45 parallel with the side walls 12 of the truck 16. Prior art strap members are substantially parallel to the side walls 12 when forcibly secured to the cargo rings 10 and 11, thereby increasing the force parallel to the side walls 12 that urges the cargo rings 10 and 11 together. The angle 43 can be reduced to about thirty degrees when the cargo boxes 40 are relatively larger than depicted in FIG. 1 and disposed closer to the side walls 12.

Further, the connecting hooks 22 are rigidly connected (not ratchet connected as prior art devices) to the strap members 20 and 21, thereby preventing the connecting hooks 22 from releasing the strap members 20 and 21 from the cargo rings 10 and 11, irrespective of the force generated by the cross straps 38 connected to the strap members 20 and 21. The adjustable length of ratchet straps included in prior art devices are capable of “slipping,” resulting in a sudden release of the tension generated by the ratchet for restrained cargo boxes 40, and correspondingly allowing movement of the cargo boxes 40 that can damage the inner side walls 12 of the pick-up truck 16 and/or cause injury to the driver of the pick-up truck 16.

The strap members 20 are fabricated from multilayered yellow nylon/polyester strap material, wire rope, wire cable, metal link chain, rope, synthetic webbing, combinations thereof and other materials well known to those of ordinary skill in the art. The strap rings 30 and 32 are fabricated from steel having a diameter of at least one-quarter inch. The strap rings 30 and 32 configurations can be annular but a “D” configuration is preferred, whereby, a linear base portion 46 of the strap rings 30 and 32 is engaged and retained between adjacent layers 47 and 48 of the strap members 20 via industrial grade threading after disposing all strap rings at selected locations between the two adjacent layers 47 and 48, resulting in strap rings 30 and 32 having an arcuately configured retaining loop 50 with an aperture 52 sufficiently large for receiving one layer 48 of a strap member 20 and hook configured ends 36 of multiple cross straps 38. The D configuration is maintained irrespective of the force generated by multiple cross straps being detachably secured to said strap rings 30 and 32. The retaining loops 50 of the strap rings 30 are dimensioned to separate the hook ends 36 of the cross straps 38 from the strap member 20 a distance that prevents the hook ends 36 of the cross straps 38 from engaging and damaging the strap members 20.

The linear base portions 46 of the “D” configuration of the strap rings 30 and 32 are secured between the two adjacent layers 47 and 48 of the strap members 20 and 21, thereby enabling the strap members 20 and 21 to be disposed in a substantially vertical position after being connected to the cargo rings 10 and 11. The vertical position of the strap members 20 and 21 results in the base portions 46 and the arcuately configured retaining loops 50 of the strap rings 30 and 32 being disposed substantially vertical; whereby, the “peaks” 53 of the arcuately configured retaining loops 50 are substantially horizontally aligned with and separated from a center line of the strap members 20 and 21, thereby maintaining a consistent force from each cross strap 38 urged upon a cargo box 40, irrespective of the hook ends 36 becoming angularly orientated relative to the strap rings 30 and 32 when the cross straps 38 forcibly engage a cargo box 40.

The peaks 53 of the strap rings 30 and 32 detachably receive the hook configured end portions 36 of cross straps 38 without causing the strap members 20 and 21 or the cross straps 38 to twist or rotate, due to the strap rings 30 and 32 separating the end portions 36 of the cross straps 38 from the strap members 20 and 21. This feature differentiates the present invention from the prior art which includes having the end portions 36 of the cross straps 38 engage apertures in the strap members detachably joined to the cargo rings 10 and 11. Preventing the strap members 20 and 21 and cross straps 38 from twisting, correspondingly reduces damage to the strap members 20 and 21, and maintains the entire surface area of the cross straps 38 upon the top portions 42 of the cargo boxes 40, thereby increasing the total force urging the bottom portions 44 of the cargo boxes 40 upon the bed 14 of the pick-up truck.

The connecting hooks 22 are fabricated from steel and include an aperture 51 for receiving an end portion 24 of a strap member 20 and 21. The end portion 24 of the strap member 20 and 21 is inserted through the aperture 51, then folded and secured via industrial thread 54, or similar means well known to shoes of ordinary skill in the art, upon an opposing wall portion of the strap member 20 and 21. The strap members 20 and 21 remain attached to the connecting hooks 22, irrespective of the force generated by the cross straps 38 upon the cargo boxes 40 and strap members 20 and 21 when the pick-up truck 16 is moving, thereby preventing cargo boxes 40 from moving vertically or horizontally upon the bed 14 of the pick-up truck 16.

Although the preferred method for securing cargo boxes 40 in the bed 14 of a pick-up truck 16 includes the step of securing a pair of cargo rings 10 and 11 to a structural portion 18 of each inner side wall 12 of a pick-up truck 16 when the cargo rings 10 and 11 are not factory installed by the manufacturer of the truck 16; an alternative method for securing cargo boxes 40 upon a bed or floor 14 of a truck 16 includes installing two longitudinally aligned strap members 20 and two longitudinally aligned strap members 21, each strap member 20 and 21 secured to three linearly aligned cargo rings 10 and 11 when operating trucks 16 having a bed or floor 14 dimensions relatively longer than the bed 14 of a pick-up truck 16. Three linear aligned cargo rings 10 and 11 for each side wall 12 can be increased when the scope of the method requires more than three cargo rings 10 and 11 secured to each inner side wall 12, when trucks 16 are encountered with attached trailers having substantially greater lengths than the lengths of inner side walls 12 requiring three lineally aligned cargo rings 10 and 11 for each side wall 12.

The remaining steps of the method for securing cargo boxes 40 to the bed or floor 14 of a truck 16 longer than a pick-up truck includes:

determining the distance separating adjacent cargo rings 10 and 11 secured to each inner side wall 12 of the truck 16;

providing strap members 20 and 21 having connecting hooks 22 secured to each end portion 24 of each strap member 20 and 21, whereby, the longitudinal length between end portions 26 of each connecting hook 22 is longer than the distance separating adjacent cargo rings 10 and 11 secured to each inner side wall 12 of the pick-up truck 16, thereby enabling each strap member 20 to be secured to adjacent cargo rings 10 and 11 secured to an inner side wall 12 of the truck 16 via said connecting hooks 22 secured to adjacent cooperating cargo rings 10 and 11, resulting in each strap member 20 and 21 having a midportion 28 of the strap member 20 and 21; and

securing a preselected quantity of strap rings 30 and 32 to each respective strap member 20 and 21, each strap ring 30 and 32 being separated a predetermined distance from an adjacent strap ring 30 and 32, whereby, strap rings 30 secured to the first strap member 20 and strap rings 32 secured to the opposing second strap member 21 detachably receive end portions 36 of adjustable length cross straps 38 that engage top portions 42 of cargo boxes 40 disposed upon the bed or floor 14 of the truck 16; whereupon, the cross straps 38 lengths are forcibly adjusted until the cross straps 38 generate sufficient tensile force that removes the sag from the midportion 38 of the strap members 20 and 21, resulting in the cross straps 38 forcibly engaging the top portions 42 of the cargo boxes 40 and correspondingly urging bottom portions 44 of the cargo boxes 40 upon the bed or floor 14 of the truck 16, thereby maintaining the position of the cargo boxes 40 upon the bed or floor 14 of the truck 16.

The foregoing description is for the purpose of illustration only and is not intended to limit the scope of protection accorded this invention. The scope of protection is to be measured by the following claims, which should be interpreted as broadly as the inventive contribution permits.

1. A Method for Securing Cargo Boxes upon the Bed of a Pick-Up Truck, said Method Comprising the Steps of:
determining the distance separating cargo rings secured to each inner side wall of a pick-up truck;
providing strap members having connecting hooks secured to each end portion of each strap member, whereby, the longitudinal length between end portions of each connecting hook is longer than the distance separating the cargo rings secured to each inner side wall of the pick-up truck, thereby enabling each strap member to be ultimately secured to a corresponding inner side wall of the pick-up truck via said connecting hooks secured to cooperating cargo rings, resulting in each strap member having a sag at a midportion of said strap member; and
securing a preselected quantity of strap rings to each strap member, each strap ring being separated a predetermined distance from an adjacent strap ring, whereby, opposing strap rings secured to opposing strap members detachably receive end portions of adjustable length cross straps that engage top portions of cargo boxes disposed in the bed of the pick-up truck; whereupon, the cross straps lengths are forcibly adjusted until the cross straps generate sufficient tensile force that removes said sag from said strap members, resulting in the cross straps forcibly engaging top portions of the cargo boxes and correspondingly urging bottom portions of the cargo boxes upon the bed of the pick-up truck, thereby maintaining the position of the cargo boxes upon the bed of the pick-up truck.

2. The Method of claim 1 wherein said sag at a midportion of said strap member distally positions said strap members and said cross straps from corresponding inner side walls of the pick-up truck, thereby increasing the angle of force imparted upon the cargo rings secured to the inner side walls of the pick-up truck, and correspondingly reducing the force vector extending parallel to the side walls that urges the cargo rings together.

3. The Method of claim 1 wherein said connecting hooks include a rectangular portion for receiving said end portion of said strap members, said end portion of said strap members being folded and secured upon an inner portion of said strap member, whereby, said strap members remain attached to said connecting hooks irrespective of the force generated by the cargo boxes upon said cross straps and correspondingly upon said strap members when the pick-up truck is moving, thereby preventing cargo boxes from moving upon the bed of the pick-up truck.

4. The Method of claim 1 wherein said step of securing a preselected quantity of strap rings to said strap members includes the step of disposing said strap rings between adjacent layers of said strap members, whereby, one layer of said strap member inserts through an aperture in said strap rings.

5. The Method of claim 1 wherein said connecting hooks include an annular portion for receiving said end portion of said strap members, said end portion of said strap members being folded and secured upon an inner portion of said strap member, whereby, said strap members remain attached to said connecting hooks irrespective of the force generated by the cargo boxes upon the said cross straps and correspondingly upon said strap members when the pick-up truck is moving, thereby preventing cargo boxes from moving upon the bed of the pick-up truck.

6. The Method of claim 4 wherein said strap rings are D configured and secured to said strap member, whereby, a base portion of said strap rings is engaged and retained between layers of said strap members, resulting in a strap ring retaining loop sufficiently large for receiving multiple cross strap ends, said retaining loop separating said cross strap ends from said strap member a distance sufficient to prevent said cross strap ends from engaging and damaging said strap members.

7. The Method of claim 5 wherein the step of providing strap members includes the step of integrally joining a swivel between said annular portion and a hook portion of said connecting hook, whereby said annular portion and said strap members are free to rotate to any position, resulting in said strap members rotating from a vertical orientation to an angled position that cooperates with cross straps angularly extending from a top wall of a cargo box, when cross straps are secured to the strap rings and a tensile force is urged upon said cross straps.

8. The Method of claim 1 wherein said adjustable length cross straps include ratchet straps, bungee cords, ropes and combinations thereof.

9. The Method of claim 6 wherein said strap ring D configuration is maintained irrespective of the force generated by multiple cross straps being detachably secured to said strap ring.

10. The Method of claim 9 wherein one strap ring secured to a first strap member detachably receives multiple cross straps connected to multiple strap rings secured to a second strap member.

11. A Method for Securing Cargo Boxes upon the Bed of a Pick-Up Truck, said Method Comprising the Steps of:
securing a pair of cargo rings to a structural portion of each inner side wall of a bed of a pick-up truck;
determining the distance separating each pair of said cargo rings secured to each inner side wall of the pick-up truck;
providing strap members having connecting hooks secured to each end portion of each strap member, whereby, the longitudinal length between end portions of each connecting hook is longer than the distance separating the cargo rings secured to each inner side wall of the pick-up truck, thereby enabling each strap member to be secured to a corresponding inner side wall of the pick-up truck via said connecting hooks secured to cooperating cargo rings, resulting in each strap member having a sag at a midportion of said strap member; and
securing a preselected quantity of strap rings to each strap member, each strap ring being separated a predetermined distance from an adjacent strap ring, whereby, opposing strap rings secured to opposing strap members detachably receive end portions of adjustable length cross straps that engage top portions of cargo boxes disposed in the bed of the pick-up truck; whereupon, the cross straps lengths are forcibly adjusted until the cross straps generate sufficient tensile force that removes said sag from said strap members, resulting in the cross straps forcibly engaging top portions of the cargo boxes and correspondingly urging bottom portions of the cargo boxes upon the bed of the pick-up truck, thereby maintaining the position of the cargo boxes upon the bed of the pick-up truck.

12. The Method of claim 11 wherein said sag at a midportion of said strap member distally positions said strap members and said cross straps from corresponding inner side walls of the pick-up truck, thereby increasing the angle of force imparted upon the cargo rings secured to the inner side walls of the pick-up truck, and correspondingly reducing the force vector extending parallel to the side walls that urges said cargo rings together.

13. The Method of claim 11 wherein said step of securing a preselected quantity of strap rings to said strap members includes the step of disposing said strap rings between adjacent layers of said strap members, whereby, one layer of said strap member inserts through an aperture in said strap rings.

14. The Method of claim 11 wherein said connecting hooks include an annular portion for receiving said end portion of said strap members, said end portion of said strap members being folded and secured upon an inner portion of said strap member, whereby, said strap members remain attached to said connecting hooks irrespective of the force generated by the cargo boxes upon the said cross straps and correspondingly upon said strap members when the pick-up truck is moving, thereby preventing cargo boxes from moving upon the bed of the pick-up truck.

15. The Method of claim 13 wherein said strap rings are D configured and secured to said strap member, whereby, a base portion of said strap rings is engaged and retained between layers of said strap members, resulting in a strap ring retaining loop sufficiently large for receiving multiple cross strap ends, said retaining loop separating said cross strap ends from said strap member a distance sufficient to prevent said cross strap ends from engaging and damaging said strap members.

16. The Method of claim 11 wherein the step of providing strap members includes the step of integrally joining a swivel between an annular portion and a hook portion of said connecting hooks, whereby said annular portion and the strap members are free to rotate to any position, resulting in said strap members rotating from a vertical orientation to an angled position that cooperates with cross straps angularly extending from a top wall of a cargo box, when cross straps are secured to the strap rings and a tensile force is urged upon said cross straps.

17. The Method of claim 11 wherein said adjustable length cross straps include ratchet straps, bungee cords, ropes and combinations thereof.

18. The Method of claim 15 wherein said strap ring D configuration is maintained irrespective of the force generated by multiple cross straps being detachably secured to said strap ring.

19. The Method of claim 18 wherein one strap ring secured to a first strap member detachably receives multiple cross straps connected to multiple strap rings secured to a second strap member.

20. A Method for Securing Cargo Boxes upon the floor of a Truck, said Method Comprising the Steps of:
determining the distance separating cargo rings secured to each inner side wall of a truck;
providing strap members having connecting hooks secured to each end portion of each strap member, whereby, the longitudinal length between end portions of each connecting hook is longer than the distance separating the cargo rings secured to each inner side wall of the pick-up truck, thereby enabling each strap member to be ultimately secured to a corresponding inner side wall of the truck via said connecting hooks secured to cooperating cargo rings, resulting in each strap member having a sag at a midportion of said strap member;
securing a preselected quantity of strap rings to each strap member, each strap ring being separated a predetermined distance from an adjacent strap ring, whereby, opposing strap rings secured to opposing strap members detachably receive end portions of adjustable length cross straps that engage top portions of cargo boxes disposed in the bed of the truck; and
integrally joining a swivel between an annular portion and a hook portion of said connecting hooks, whereby said annular portion and said strap members are free to rotate to any position, resulting in said strap members rotating from a vertical orientation to an angled position that cooperates with cross straps angularly extending from a top wall of a cargo box, when cross straps are secured to the strap rings and a tensile force is urged upon the cross straps; whereupon, said cross straps lengths are forcibly extended until said cross straps generate sufficient tensile force that removes said sag from said strap members, resulting in said cross straps forcibly engaging top portions of the cargo boxes and correspondingly urging bottom portions of the cargo boxes upon the bed of the truck, thereby maintaining the position of the cargo boxes upon the bed of the truck.
